(19) United States
(12) Patent Application Publication
(10) Pub. No.: US 2013/0056986 A1
(43) Pub. Date: Mar. 7, 2013

(54) WIND POWER GENERATION SYSTEM AND METHOD FOR CONTROLLING THE SAME

(71) Applicants: Young Hak Jeong, Gyeonggi-do (KR); Chan Yoon, Seoul (KR); Hyun Chul Jung, Gyeonggi-do (KR); Bae Kyun Kim, Gyeonggi-do (KR)

(72) Inventors: Young Hak Jeong, Gyeonggi-do (KR); Chan Yoon, Seoul (KR); Hyun Chul Jung, Gyeonggi-do (KR); Bae Kyun Kim, Gyeonggi-do (KR)

(21) Appl. No.: 13/595,989

(22) Filed: Aug. 27, 2012

(30) Foreign Application Priority Data
Sep. 6, 2011 (KR) 10-2011-0090170

(51) Int. Cl. H02J 7/14

(52) U.S. Cl. 290/50

(57) ABSTRACT

Disclosed herein are a wind power generation system including: a wind power generation unit converting wind energy into electrical energy and outputting the electrical energy; a wind power generation controlling unit controlling the electrical energy output from the wind power generation unit; and a capacitor unit and a battery unit storing the electrical energy controlled by the wind power generation controlling unit, wherein the wind power generation controlling unit includes a direct current (DC)-direct current (DC) converter monitoring the wind power generation unit and the capacitor unit to thereby selectively boost the electrical energy output from the wind power generation unit, and a method for controlling the same.

### CROSS REFERENCE TO RELATED APPLICATIONS

This application claims the benefit under 35 U.S.C. Section 119 of Korean Patent Application Serial No. 10-2011-0090170, entitled “Wind Power Generation System and Method for Controlling the Same” filed on Sep. 6, 2011, which is hereby incorporated by reference in its entirety into this application.

### BACKGROUND OF THE INVENTION

1. Technical Field

The present invention relates to a wind power generation system and a method for controlling the same, and more particularly, to a wind power generation system capable of extending a lifespan of an energy storage device such as a battery unit, or the like, improving storage characteristics of electrical energy generated at a low wind speed, and stably supplying electrical energy to a battery unit through a capacitor unit, and a method for controlling the same.

2. Description of the Related Art

A wind power generation system using wind energy, which is a power generation system substituting for the existing energy generation system using fossil fuel, has been used as a continuable power generation system using clean energy.

The wind power generation system according to the related art is configured to include a wind power generation unit, a wind power generation controlling unit, and a battery unit as shown in FIG. 1.

More specifically, the wind power generation unit converts wind energy into electrical energy and outputs the electrical energy. That is, the wind power generation unit is a wind speed generator generating power using a wind speed.

In addition, the wind power generation controlling unit converts the electrical energy, that is, alternating current (AC) power, output from the wind power generation unit into direct current (DC) power and supplies the DC power to the battery unit.

Therefore, the battery unit receives and stores the DC power and then provides the DC power to each load connected to the wind power generation system.

However, the wind power generation system according to the related art configured as described above has a disadvantage in that it has an unstable and discontinuous output according to weather conditions such as a wind speed, a wind direction, a season, or the like.

Therefore, since electrical energy, that is, input power, supplied to the battery unit is not constant but is similar to pulse application varied at every instant, a lifespan of the battery unit is significantly deteriorated.

Further, the wind power generation unit generates low power at a low wind speed. At this time, since the battery unit has large input resistance, it is difficult to store low power, such that energy storage efficiency is deteriorated.

Furthermore, since the wind power generation controlling unit boosts the low power generated in the wind power generation unit up to system power of the battery unit, when the generated power is low DC voltage, boosting efficiency is low, such that charging efficiency is deteriorated as compared to power generation.

### SUMMARY OF THE INVENTION

An object of the present invention is to provide a wind power generation system capable of extending a lifespan of an energy storage device such as a battery unit, or the like, and a method for controlling the same.

Another object of the present invention is to provide a wind power generation system capable of improving storage characteristics of electrical energy generated at a low wind speed, and a method for controlling the same.

Still another aspect of the present invention is to provide a wind power generation system capable of stably supplying electrical energy generated by wind power generation to a battery unit through a capacitor unit, and a method for controlling the same.

According to an exemplary embodiment of the present invention, there is provided a wind power generation system including: a wind power generation unit converting wind energy into electrical energy and outputting the electrical energy; a wind power generation controlling unit controlling the electrical energy output from the wind power generation unit; and a capacitor unit and a battery unit storing the electrical energy controlled by the wind power generation controlling unit, wherein the wind power generation controlling unit includes a direct current (DC)-direct current (DC) converter monitoring the wind power generation unit and the capacitor unit to thereby selectively boost the electrical energy output from the wind power generation unit.

The DC-DC converter may include a first converter boosting the electrical energy output from the wind power generation unit up to a reference amount when the electrical energies of the wind power generation unit and the capacitor unit are less than a reference amount and a second converter boosting the electrical energy output from the wind power generation unit up to a maximum storage amount of the capacitor unit when the electrical energy of the wind power generation unit or the capacitor unit is the reference amount or more.

The capacitor unit may include a supercapacitor module in which a plurality of capacitors are stack-connected to each other, the battery unit includes a battery module in which a plurality of batteries may be stack-connected to each other, and the capacitor unit and the battery unit may be connected in series with each other.

The wind power generation controlling unit may further include a capacitor overcharge preventing unit monitoring the capacitor unit to interrupt the electrical energy supplied from the wind power generation unit to the capacitor unit, thereby preventing overcharge of the capacitor unit.

The wind power generation system may further include a battery controlling unit provided between the capacitor unit and the battery unit to thereby control the electrical energy supplied from the capacitor unit to the battery unit.

According to another exemplary embodiment of the present invention, there is provided a method for controlling a wind power generation system, the method including: a generation step converting wind energy into electrical energy and outputting the electrical energy; a boosting step monitoring a wind power generation unit and a capacitor unit to thereby selectively boost the electrical energy output from the wind power generation unit; and a storing step storing the selectively boosted electrical energy.

In the boosting step, the electrical energy output from the wind power generation unit may be boosted up to a reference amount when electrical energies of the wind power generation unit and the capacitor unit are less than the reference amount, and the electrical energy output from the wind power generation unit may be boosted up to a maximum storage amount of the capacitor unit when the electrical energy of the wind power generation unit or the capacitor unit are the reference amount or more.

The method may further include an overcharge preventing step monitoring the capacitor unit to interrupt the electrical energy supplied from the wind power generation unit to the capacitor unit, thereby preventing overcharge of the capacitor unit.

In the overcharge preventing step, the electrical energy supplied to the capacitor unit may be interrupted when the electrical energy of the capacitor unit is larger than maximum storable electrical energy, and the supply of the electrical energy to the capacitor unit may be maintained when the electrical energy of the capacitor unit is smaller than the maximum storable electrical energy.

### BRIEF DESCRIPTION OF THE DRAWINGS

FIG. 1 is a block diagram schematically showing a wind power generation system according to the related art;

FIG. 2 is a block diagram schematically showing a wind power generation system according to an exemplary embodiment of the present invention;

FIG. 3 is a block diagram schematically showing a wind power generation controlling unit of FIG. 2;

FIG. 4 is a flow chart describing a process of preventing overcharge of a capacitor unit in the wind power generation system according to the exemplary embodiment of the present invention; and

FIG. 5 is a flow chart describing a process of selectively boosting electrical energy output from a wind power generation unit in the wind power generation system according to the exemplary embodiment of the present invention.

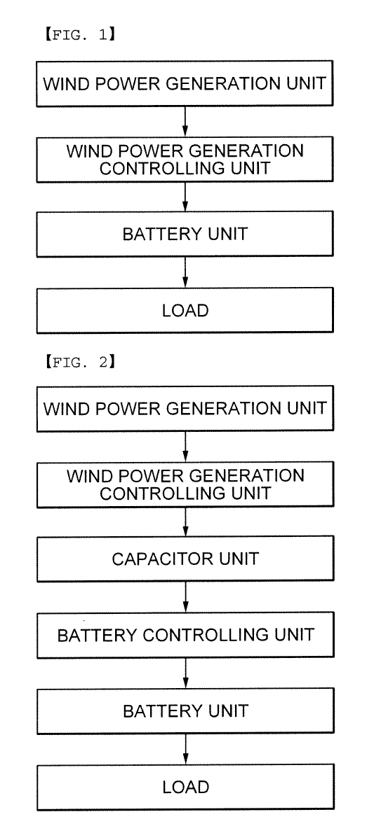

### DESCRIPTION OF THE PREFERRED EMBODIMENTS

Exemplary embodiments of the present invention in which objects of the present invention may be specifically implemented will be described with reference to the accompanying drawings. In exemplary embodiments of the present invention, the same terms and reference numerals will be used to describe the same components. Therefore, an additional description for the same component will be omitted below.

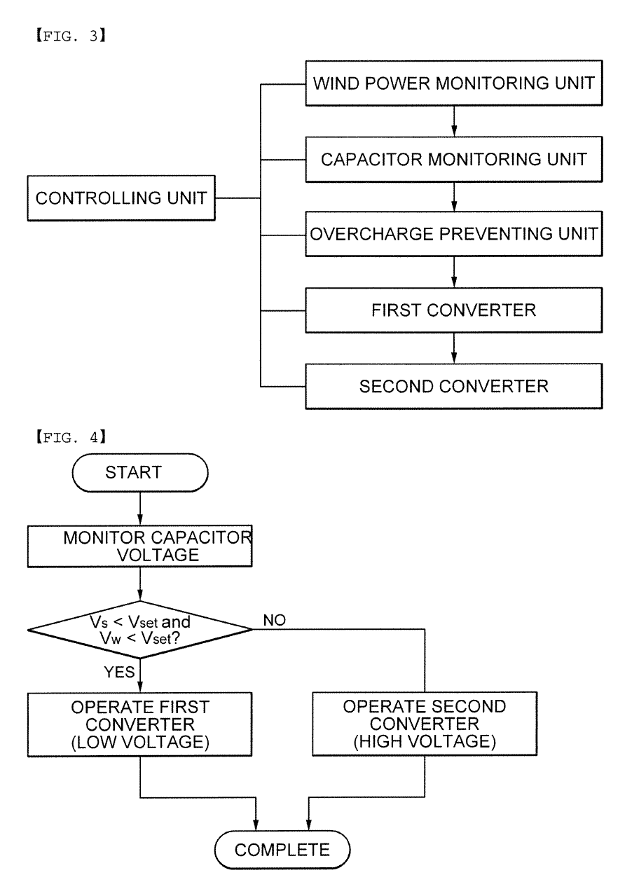

Hereinafter, a wind power generation system and a method for controlling the same according to an exemplary embodiment of the present invention will be described with reference to FIGS. 2 to 5.

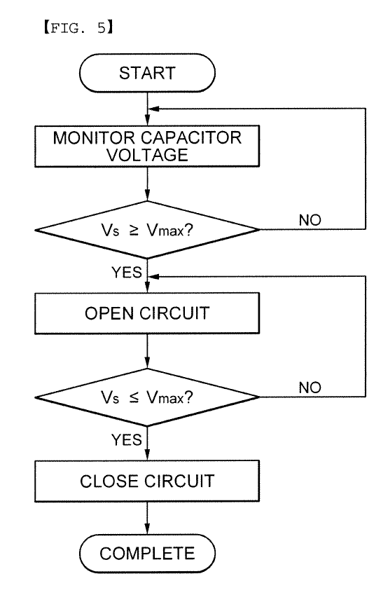

FIG. 2 is a block diagram schematically showing a wind power generation system according to an exemplary embodiment of the present invention; FIG. 3 is a block diagram schematically showing a wind power generation controlling unit of FIG. 2; FIG. 4 is a flow chart describing a process of preventing overcharge of a capacitor unit in the wind power generation system according to the exemplary embodiment of the present invention; and FIG. 5 is a flow chart describing a process of selectively boosting electrical energy output from a wind power generation unit in the wind power generation system according to the exemplary embodiment of the present invention.

First referring to FIGS. 2 and 3, the wind power generation system according to the exemplary embodiment of the present invention may be mainly configured to include a wind power generation unit, a wind power generation controlling unit, a capacitor unit, and a battery unit.

The wind power generation unit may convert wind energy into electrical energy and output the electrical energy, the wind power generation controlling unit may control the electrical energy output from the wind power generation unit, and the capacitor unit and the battery unit may store the electrical energy controlled by the wind power generation controlling unit.

Here, the wind power generation controlling unit may be configured to monitor the wind power generation unit and the capacitor unit to thereby selectively boost the electrical energy output from the wind power generation unit.

Therefore, the wind power generation controlling unit may be configured to include a wind power monitoring unit monitoring the electrical energy, that is, output power or output voltage, output from the wind power generation unit, a capacitor monitoring unit monitoring electrical energy, that is, stored power or stored voltage, of the capacitor unit, a direct current (DC)-direct current (DC) converter selectively boosting the output power or the output voltage, and a controlling unit controlling the wind power monitoring unit, the capacitor monitoring unit, and the DC-DC converter.

Here, the DC-DC converter may be configured to include a first converter boosting the electrical energy output from the wind power generation unit up to a reference amount when the electrical energies of the wind power generation unit and the capacitor unit are less than the reference amount and a second converter boosting the electrical energy output from the wind power generation unit up to a maximum storage amount of the capacitor unit when the electrical energies of the wind power generation unit and the capacitor unit are the reference amount or more, wherein the first and second converter may be a boost type converter.

That is, in the wind power generation system according to the present embodiment, the DC-DC converter is configured in at least two-stage form including the first and second converters, such that the DC-DC converter may flexibly cope with an electrical energy state, that is, a power or voltage state, of the capacitor unit, and the electrical energy, that is, a power or voltage condition, output from the wind power generation unit. Therefore, it is possible to maximize boosting efficiency.

For example, as shown in FIG. 4, assuming that the capacitor unit includes a supercapacitor module in which a plurality of capacitors are stack-connected to each other, voltage may be boosted up to the maximum of 16 V, and a set reference voltage Vset is 8 V, voltage Vw output from the wind power generation unit may be boosted only up to 8 V through the first converter when both of the voltage Vw output from the wind power generation unit and voltage Vs of the capacitor unit are lower than the reference voltage Vset, and the voltage Vw output from the wind power generation unit may be boosted up to 16 V through the second convert when any one of the voltage Vw output from the wind power generation unit and the voltage Vs of the capacitor unit is higher than the reference voltage Vset.

That is, the first converter boosts the voltage output from the wind power generation unit at a lower wind speed and the second converter boosts the voltage output from the wind power generation unit at a high wind speed, thereby making it possible to raise boosting efficiency of the DC-DC converter and improve storage characteristics of the electrical energy at the low wind speed.

Meanwhile, the wind power generation controlling unit may further include a capacitor overcharge preventing unit monitoring the capacitor unit to interrupt the electrical energy supplied from the wind power generation unit to the capacitor unit, thereby preventing overcharge of the capacitor unit.

For example, as shown in FIG. 5, the overcharge preventing unit monitors the capacitor unit and opens a circuit configuring the overcharge preventing unit through a ground for switching, or the like, when the electrical energy, that is, the voltage Vs, of the capacitor unit exceeds maximum voltage Vmax that may be stored in the capacitor unit to interrupt the electrical energy supplied from the wind power generation unit to the capacitor unit, thereby making it possible to prevent the overcharge of the capacitor unit.

The overcharge preventing unit closes the circuit configuring the overcharge preventing unit when the electrical energy, that is, the voltage Vs, of the capacitor unit is equal to or less than maximum voltage Vmax that may be stored in the capacitor unit, thereby making it possible to supply the electrical energy from the wind power generation unit to the capacitor unit through the wind power generation controlling unit.

Meanwhile, the battery unit may include a battery module in which a plurality of batteries are stack-connected to each other, and the capacitor unit and the battery unit are connected in series with each other, thereby making it possible to stably supply the electrical energy stored in the capacitor unit to the battery unit.

Here, a battery controlling unit is provided between the capacitor unit and the battery unit, thereby making it possible to smoothly control the electrical energy supplied from the capacitor unit to the battery unit.

For example, although not shown in detail, the battery controlling unit may include a battery monitoring unit monitoring the battery unit and a DC-DC converter controlling the electrical energy supplied to the battery unit. Here, the DC-DC converter of the battery controlling unit may be a constant current type boost converter in order to improve a lifespan of the battery unit.

In addition, although not shown in detail, the battery controlling unit may include an overcharge preventing unit preventing overcharge of the battery unit, similar to the capacitor unit described above.

Next, a method for controlling a wind power generation system according to the exemplary embodiment of the present invention may include a generation step converting wind energy into electrical energy and outputting the electrical energy, a boosting step monitoring the wind power generation unit and the capacitor unit to thereby selectively boost the electrical energy output from the wind power generation unit, and a storing step storing the selectively boosted electrical energy.

Here, in the boosting step, the electrical energy, that is, the voltage Vw, output from the wind power generation unit may be boosted up to the reference voltage Vset when the electrical energies, that is, each voltage Vs or Vw, of the wind power generation unit and the capacitor unit are less than the reference amount, that is, the reference voltage Vset, and the electrical energy, that is, the voltage Vw, output from the wind power generation unit may be boosted up to a maximum storage amount, that is, maximum storable voltage, of the capacitor unit when the voltage Vw of the wind power generation unit or the voltage Vs of the capacitor unit are the reference voltage Vset or more.

Meanwhile, the method for controlling a wind power generation system may further include an overcharge preventing step monitoring the capacitor unit to interrupt the electrical energy supplied from the wind power generation unit to the capacitor unit, thereby preventing overcharge of the capacitor unit.

That is, in the overcharge preventing step, the electrical energy supplied to the capacitor unit may be interrupted when the electrical energy, that is, the voltage Vs, of the capacitor unit is larger than the maximum storable electrical energy, that is, the maximum storable voltage Vmax, and the supply of the electrical energy, that is, the power or the voltage, to the capacitor unit may be continuously maintained when the voltage Vs, of the capacitor unit is smaller than the maximum storable voltage Vmax.

As set forth above, with the wind power generation system and the method for controlling the same according to the exemplary embodiments of the present invention, it is possible to provide a wind power generation system capable of extending a lifespan of an energy storage device such as a battery unit, or the like, and a method for controlling the same.

In addition, it is possible to provide a wind power generation system capable of improving storage characteristics of electrical energy generated at a low wind speed, and a method for controlling the same.

Further, it is possible to provide a wind power generation system capable of stably supplying electrical energy generated by wind power generation to a battery unit through a capacitor unit, and a method for controlling the same.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A wind power generation system comprising:
a wind power generation unit converting wind energy into electrical energy and outputting the electrical energy;
a wind power generation controlling unit controlling the electrical energy output from the wind power generation unit; and
a capacitor unit and a battery unit storing the electrical energy controlled by the wind power generation controlling unit,
wherein the wind power generation controlling unit includes a direct current (DC)-direct current (DC) converter monitoring the wind power generation unit and the capacitor unit to thereby selectively boost the electrical energy output from the wind power generation unit.

2. The wind power generation system according to claim 1, wherein the DC-DC converter includes a first converter boosting the electrical energy output from the wind power generation unit up to a reference amount when the electrical energies of the wind power generation unit and the capacitor unit are less than a reference amount and a second converter boosting the electrical energy output from the wind power generation unit up to a maximum storage amount of the capacitor unit when the electrical energy of the wind power generation unit or the capacitor unit is the reference amount or more.

3. The wind power generation system according to claim 1, wherein the capacitor unit includes a supercapacitor module in which a plurality of capacitors are stack-connected to each other, and the battery unit includes a battery module in which a plurality of batteries are stack-connected to each other; and
wherein the capacitor unit and the battery unit are connected in series with each other.

4. The wind power generation system according to claim 1, wherein the wind power generation controlling unit further includes a capacitor overcharge preventing unit monitoring the capacitor unit to interrupt the electrical energy supplied from the wind power generation unit to the capacitor unit, thereby preventing overcharge of the capacitor unit.

5. The wind power generation system according to claim 1, further comprising a battery controlling unit provided between the capacitor unit and the battery unit to thereby control the electrical energy supplied from the capacitor unit to the battery unit.

6. A method for controlling a wind power generation system, the method comprising:
a generation step converting wind energy into electrical energy and outputting the electrical energy;
a boosting step monitoring a wind power generation unit and a capacitor unit to thereby selectively boost the electrical energy output from the wind power generation unit; and
a storing step storing the selectively boosted electrical energy.

7. The method according to claim 6, wherein in the boosting step, the electrical energy output from the wind power generation unit is boosted up to a reference amount when electrical energies of the wind power generation unit and the capacitor unit are less than the reference amount, and the electrical energy output from the wind power generation unit is boosted up to maximum storage amount of the capacitor unit when the electrical energy of the wind power generation unit or the capacitor unit are the reference amount or more.

8. The method according to claim 6, further comprising an overcharge preventing step monitoring the capacitor unit to interrupt the electrical energy supplied from the wind power generation unit to the capacitor unit, thereby preventing overcharge of the capacitor unit.

9. The method according to claim 8, wherein in the overcharge preventing step, the electrical energy supplied to the capacitor unit is interrupted when the electrical energy of the capacitor unit is larger than a maximum storable electrical energy, and the supply of the electrical energy to the capacitor unit is maintained when the electrical energy of the capacitor unit is smaller than the maximum storable electrical energy.
